(19) United States
(12) Patent Application Publication
(10) Pub. No.: US 2026/0361767 A1
(43) Pub. Date: Nov. 12, 2026

(54) POLICY ANALYSIS USING POLICY INTERMEDIATE LANGUAGE

(71) Applicant: Oracle International Corporation, Redwood Shores, CA (US)

(72) Inventors: Kostyantyn VOROBYOV, Brisbane (AU); Padmanabhan KRISHNAN, Brisbane (AU); François GAUTHIER, Brisbane (AU); Alexander JORDAN, Vienna (AT)

(73) Assignee: Oracle International Corporation, Redwood Shores, CA (US)

(21) Appl. No.: 19/201,794

(22) Filed: May 7, 2025

(51) Int. Cl. H04L 9/40

(52) U.S. Cl. CPC H04L 63/20

(57) ABSTRACT

A method implements policy analysis using a policy intermediate language. The method involves receiving a set of policy specifications conforming to a set of policy languages. The method further involves translating the set of policy specifications to an intermediate specification that conforms to a policy intermediate language. The intermediate specification includes a set of entity definitions that define multiple entities identified by the set of policy specifications. The intermediate specification also includes a set of relation definitions that define multiple relations between the multiple entities. The intermediate specification further includes a set of assertion definitions that define logical properties using one or more of the entity definitions and the relation definitions. The method further involves processing the intermediate specification to detect an issue in the intermediate specification derived from the set of policy specifications. The method further involves displaying the issue.

### BACKGROUND

Cloud security is a complex issue with different providers having different collections of mechanisms and protocols covering issues, such as identity management, networking, and access control. Numerous languages are available to generate policy specifications that enumerate entities (users, system resources, etc.) and the relations between entities. The available languages may be arbitrarily complex and are not cross compatible. Policies written in authorization and access control policy languages may not specify network-level protections. Security requirements are heterogeneous and may depend on the usage context (e.g., application, database, infrastructure, and network levels).

Further complicating the understanding of a security posture, concepts like security zones may be applied to databases, networks, cloud-based computers, or storage. Security zones may be written with deny specifications, which are different from the policy specifications used for access or identity management. Even if an access management policy specification permits access, a security zone may prevent access. Conflicts between policy specifications leads to a hierarchy between the policy specifications that further complicates the analysis of a security posture. A challenge is to develop a tool that can analyze an array of different policy specifications conforming to incompatible policy languages.

### SUMMARY

In general, in one or more aspects, the disclosure relates to a method for policy analysis using a policy intermediate language. The method involves receiving a set of policy specifications conforming to a set of policy languages. The method further involves translating the set of policy specifications to an intermediate specification that conforms to a policy intermediate language. The intermediate specification includes a set of entity definitions that define multiple entities identified by the set of policy specifications. The intermediate specification also includes a set of relation definitions that define multiple relations between the multiple entities. The intermediate specification further includes a set of assertion definitions that define logical properties using one or more of the entity definitions and the relation definitions. The method further involves processing the intermediate specification to detect an issue in the intermediate specification derived from the set of policy specifications. The method further involves displaying the issue.

In general, in one or more aspects, the disclosure relates to a system that includes at least one processor and an application that executes on the at least one processor. Executing the application performs receiving a set of policy specifications conforming to a set of policy languages. Executing the application further performs translating the set of policy specifications to an intermediate specification that conforms to a policy intermediate language. The intermediate specification includes a set of entity definitions that define multiple entities identified by the set of policy specifications. The intermediate specification also includes a set of relation definitions that define multiple relations between the multiple entities. The intermediate specification further includes a set of assertion definitions that define logical properties using one or more of the entity definitions and the relation definitions. Executing the application further performs processing the intermediate specification to detect an issue in the intermediate specification derived from the set of policy specifications. Executing the application further performs displaying the issue.

In general, in one or more aspects, the disclosure relates to a non-transitory computer readable medium including instructions executable by at least one processor. Executing the instructions performs receiving a set of policy specifications conforming to a set of policy languages. Executing the instructions further performs translating the set of policy specifications to an intermediate specification that conforms to a policy intermediate language. The intermediate specification includes a set of entity definitions that define multiple entities identified by the set of policy specifications. The intermediate specification also includes a set of relation definitions that define multiple relations between the multiple entities. The intermediate specification further includes a set of assertion definitions that define logical properties using one or more of the entity definitions and the relation definitions. Executing the instructions further performs processing the intermediate specification to detect an issue in the intermediate specification derived from the set of policy specifications. Executing the instructions further performs displaying the issue.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, FIG. 5, and FIG. 6 show examples in accordance with the disclosure.

FIG. 7A and FIG. 7B show computing systems in accordance with the disclosure.

Similar elements in the various figures may be denoted by similar names and reference numerals. The details of the features and elements described in one figure may extend to similarly named features and elements in different figures.

### DETAILED DESCRIPTION

Embodiments of the disclosure perform policy analysis using policy intermediate language of different policy specifications that conform to incompatible policy languages. To analyze the different policy specifications written with different policy languages an intermediate specification is generated that utilizes a policy intermediate language. The intermediate specification conforms to the policy intermediate language to provide an intermediate representation of the different policy specifications.

An advantage of using the policy intermediate language to generate an intermediate specification to form an intermediate representation of the different policy specifications is that the addition of additional policy specifications written in different policy languages may be included by using a translator that converts from the policy language to the policy intermediate language. By using a translator, a policy analysis engine may remain unchanged to analyze policy specifications that conform to different or additional policy languages. Without using an intermediate representation, the policy analysis engine would be revised for each additional policy language to account for interactions between the different policy specifications conforming to the different policy languages.

The policy intermediate language used to generate an intermediate representation stored as an intermediate specification specifies a grammar and syntax used in the intermediate specification to define entities, relations, assertions, and combinations therebetween. An application developed and deployed using a cloud architecture, may include multiple policy specifications conforming to multiple policy languages. The multiple policy specifications may be converted to an intermediate specification for analysis. The analysis of the intermediate specification may detect several types of issues including issues related to reachability, misconfigurations, least privilege violations, information leaks, tag based information flow, etc. Based on the analysis of the intermediate specification, analysis messages may be generated to identify issues with the policy specifications for an application. Based on the analysis messages, policy revisions may be generated to update the policy specifications and resolve the issues identified in the analysis. Computing systems may display the policy specifications, the intermediate specification, the analysis messages, and the policy revisions in a dynamic user interface that may adjust layouts responsive to the issues identified and feedback from the user.

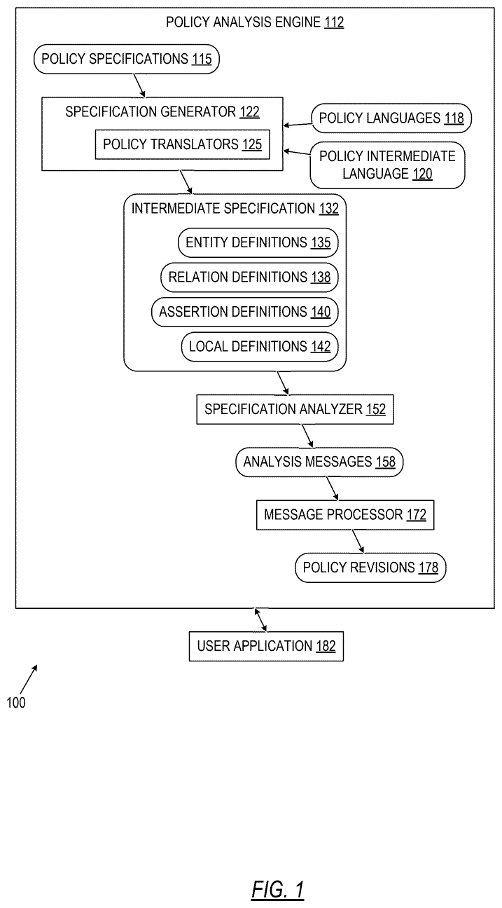

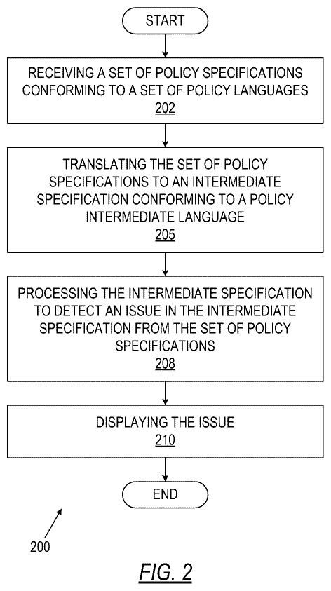

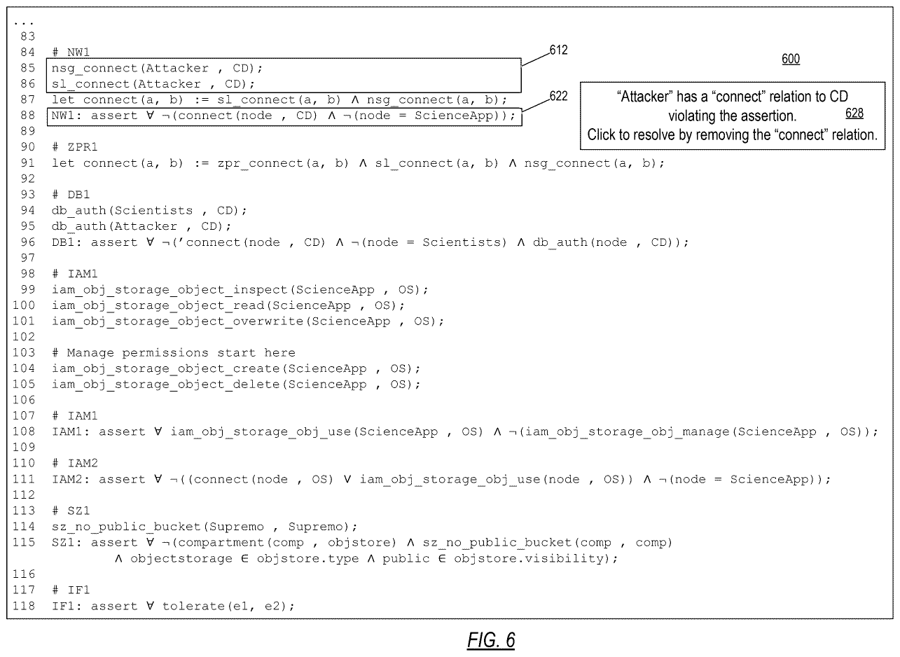

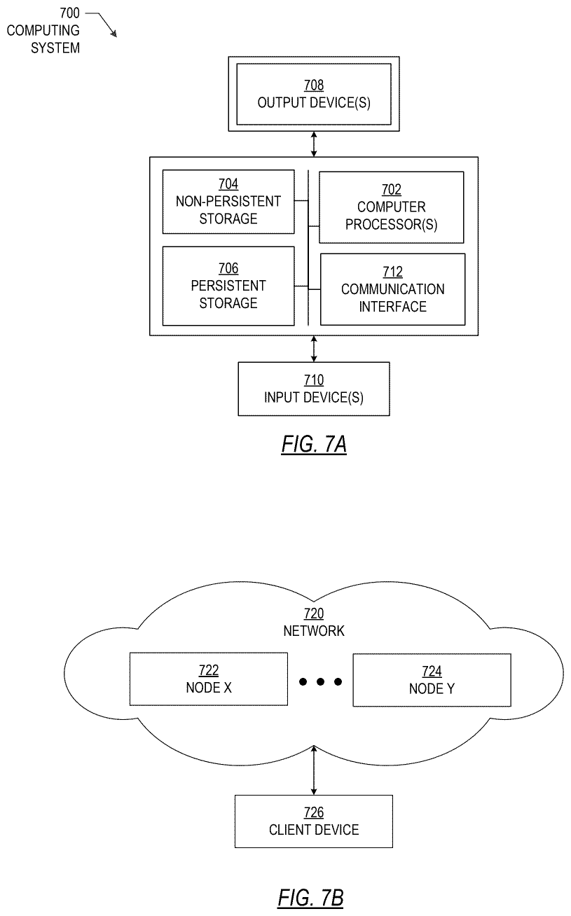

Turning to FIG. 1, the system (100) includes components of one or more computing systems implementing formal specification assisted program repair. The components of the system (100) may each include hardware and software components that may be implemented as part of the computing systems described in the other figures, including those of FIG. 7A and FIG. 7B. The system (100) includes the policy analysis engine (112) and the user application (182).

The policy analysis engine (112) is a collection of programs that may operate to process the policy specifications (115) to generate the intermediate specification (132) using the policy intermediate language (120). The policy analysis engine (112) may further process the intermediate specification (132) to generate the analysis messages (158) and the policy revisions (178). The policy analysis engine (112) may utilize the specification generator (122), the specification analyzer (152), and the message processor (172) to process the policy specifications (115) and generate the intermediate specification (132), the analysis messages (158), and the policy revisions (178).

Data utilized by the policy analysis engine (112), including the policy specifications (115), the policy languages (118), a policy intermediate language, (120), the intermediate specification (132), the analysis messages (158), and the policy revisions (178), may be electronic records that are stored and transmitted within the computing system. The electronic records may be stored in data structures in data storage that may be accessed using file systems, databases, etc.

The policy specifications (115) are collections of records that specify rules and conditions that govern security related to an application, which may include authorization, authentication, network security, database security, information flow, etc. The policy specifications (115) may define permissions for accessing resources, rules for network connectivity, and protocols for managing data flow between entities.

The policy specifications (115) may be stored in a structured format, such as configuration files using JavaScript Object Notation (JSON), Extensible Markup Language (XML), or YAML Ain't Markup Language (YAML), relational or NoSQL (Not Only SQL) databases, specialized policy management systems, cloud-based storage solutions, version control systems like Git, etc. The policy specifications (115) may also be embedded directly into application code.

The policy languages (118) are the languages that define the syntax and semantics used by the policy specifications (115). The syntax and semantics establish the formal structure and meaning of terms and phrases used by the policy specifications (115) in conformance with the policy languages (118). Different cloud service providers may utilize provider specific languages for the resources managed by the cloud service provider. The policy languages (118) may be high-level, expressing constraints independent of enforcement mechanisms, or low-level, detailing specific program options, inputs, or characteristics of entities within a system. Examples of policy languages include eXtensible Access Control Markup Language (XACML), Open Digital Rights Language (ODRL), and Platform for Privacy Preferences Project (P3P).

The policy intermediate language (120) is a language that specifies the syntax and semantics for the intermediate specification (132). The syntax and semantics defined by the policy intermediate language (120) are broad enough to encompass the entities and relations defined by the policy specifications (115) using the policy languages (118).

The specification generator (122) is a program that generates the intermediate specification (132) from the policy specifications (115) that are in conformance with the policy languages (118). The specification generator (122) generates the intermediate specification (132) to be in conformance with the policy intermediate language (120). The specification generator (122) may use the policy translators (125) to translate the policy specifications (115) to the intermediate specification (132).

The policy translators (125) are components of the specification generator (122). The policy translators (125) translate the policy specifications (115) to the intermediate specification (132). One of the policy translators (125) may correspond to one of the policy languages (118) and be used to translate multiple policy specifications.

The intermediate specification (132) is a translation of the policy specifications (115) from the policy languages (118) to the policy intermediate language (120). The intermediate specification (132) may be a single data structure that includes information from multiple policy specifications that are rewritten to be in conformance with the policy intermediate language (120). The intermediate specification (132), in conformance with the policy intermediate language (120), may include multiple definitions for entities relations, assertions, etc., as well as local definitions.

The entity definitions (135) are definitions within the intermediate specification (132) that define entities. An entity may be a user, a process, a resource, etc. An entity definition may include a name for an entity and a type for the entity.

The relation definitions (138) are definitions with the intermediate specification (132) that define relations between entities. Relations are construct that encapsulate interactions and permissions between entities. A relation definition may include a name of the relation and the names of the entities to which the relation applies. For example, the relation definitions (138) may specify network connectivity, such as “nsg(A, B)” indicating communication permissions within a network security group, and “sl(A, B)” specifying communication permissions within a security list. Permissions may also be expressed as relations. As another example, “iam_obj_storage_object_inspect(A, O)” is a relation definition granting entity “A” the ability to inspect object storage “O,” and “iam_obj_storage_object_read(B, O)” is a relation definition that permits entity “B” to read object storage “O.” Relation definitions may also capture information flow dynamics, including declassification and endorsement processes.

The assertion definitions (140) are definitions within the intermediate specification (132) that define assertions. An assertion is a logical property that the complete set of policy specifications may satisfy. If an assertion is not satisfied then there may be an issue with one or more of the policy specifications (115). Assertions may be constructed using the entities and relations defined in the policy intermediate language. Assertions may be used to specify and enforce security requirements within the cloud security policies. As an example, the assertion “assert ∀ node: sl(node, DB)→(node !=User)” states that if a node can connect to a database, the node may not be a user.

The local definitions (142) are definitions within the intermediate specification (132) that may define compound relations. A local definition may be written as a compact way to express certain conditions within the intermediate specification using other definitions within the intermediate specification. For example, the intermediate specification (132) may include the statement “let connect(a, b):=sl_connect(a, b) ∧ nsg_connect(a, b) ∧ zpr_connect(a, b)” as a local definition. The statement is a local definition that states that entities “a” and “b” may connect when three individual connection-relations (“sl_connect”, “nsg_connect”, and “zpr_connect”) hold true simultaneously.

The specification analyzer (152) is a component of the policy analysis engine (212). The specification analyzer (152) analyzes the intermediate specification (132) to generate the analysis messages (158). For example, the specification analyzer (152) may process the assertion definitions (140) within the intermediate specification (132) to determine if there are issues within the policy specifications (115). The issues detected by the specification analyzer (152) may be enumerated in the analysis messages (158).

The analysis messages (158) are outputs from the specification analyzer (152) that may be input to the message processor (172). The analysis messages (158) may identify issues detected by the specification analyzer (152).

The message processor (172) is a component of the policy analysis engine (112). The message processor (172) processes the analysis messages (158) to generate the policy revisions (178). The message processor (172) may further incorporate the policy revisions (178) into the policy specifications (115).

The policy revisions (178) are revisions for the policy specifications (115). The policy revisions (178) may include changes for the policy specifications (115) that, when incorporated into the policy specifications (115), may remove the issues identified in the analysis messages (158).

The user application (182) is an application that may operate on a computing system to display information from the policy analysis engine (112) in an interactive graphical user interface. The user application (182) may display the policy specifications (115), the intermediate specification (132), the analysis messages (158), the policy revisions (178), etc. Responsive to user interaction, the user application (182) may identify the policy specifications (115) and display the intermediate specification (132), the analysis messages (158), and the policy revisions (178). The user application (182) may further display the policy specifications (115) after being updated with the policy revisions (178).

FIG. 2 shows a flowchart of a method implementing policy analysis using a policy intermediate language. The method of FIG. 2 may be implemented using the systems described in the other figures, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process (200) generates candidate patches to implement formal specification assisted program repair. The process (200) may include multiple steps (e.g., Block 202 through Block 212) that may execute on the components described in the other figures, including those of FIG. 1, FIG. 7A, and FIG. 7B.

Block 202 involves receiving a set of policy specifications conforming to a set of policy languages. Receiving a set of policy specifications may involve transferring the policy specifications from one or more service providers to a repository to consolidate the policy specifications to a single data storage. The set of policy specifications may be identified by a user with a user interface. The set of policy specifications may also be identified in a configuration file of an application for which a security analysis may be performed.

Block 205 involves translating the set of policy specifications to an intermediate specification conforming to a policy intermediate language. The intermediate specification may include a set of entity definitions defining a set of entities identified by the set of policy specifications, a set of relation definitions defining a set of relations between the set of entities, and a set of assertion definitions defining logical properties using one or more of the set of entity definitions and the set of relation definitions. The intermediate specification may also include a set of local definitions defining a set of compound relations using the set of relation definitions. Translating the set of policy specifications to an intermediate specification may involve identifying the policy language used for each of the policy languages. The policy specifications for each of the policy languages may be sent to corresponding translators. A translator translates the policy specifications from one of the policy languages to the policy intermediate language to form an intermediate representation stored as an intermediate specification. An intermediate specification may be generated for each of the policy specifications which may be consolidated into a single intermediate specification. The translator may map definitions from a policy specification in a policy language to the intermediate specification in the policy intermediate language. The mapping performed by the translator converts the definitions of entities, relations, assertions etc., from the syntax and semantics of the policy language to the syntax and semantics of the policy intermediate language.

Block 208 involves processing the intermediate specification to detect an issue in the intermediate specification from the set of policy specifications. Several types of issues may be detected, including reachability issues, misconfigurations, authentication issues, least-privilege violations, information leaks, validations, etc.

Processing the intermediate specification may involve determining reachability between the set of entities by processing the set of entity definitions using transitive closure definitions to identify indirect connections between the set of entities. Determining reachability may involve identifying indirect connections between entities that are not directly linked but can be connected through a series of intermediate entities. The entity definitions provided in the policy specifications are processed to identify information about the attributes and direct connections of entities to other entities. Transitive closure definitions are applied to the entity definitions. Transitive closure is a mathematical concept that extends the reachability of entities by considering indirect connections. Transitive closure involves iteratively combining direct connections to form longer paths. Indirect connections are identified between entities that can be established through one or more intermediate entities, even if the entities are not directly connected. The reachability of each entity may be evaluated by both direct and indirect connections, which may then be compared against assertions, allow lists, deny lists, etc., to identify reachability issues for the entities defined in the intermediate specification generated from the policy specifications.

Processing the intermediate specification involves detecting a misconfiguration in one or more of a network security group and a security list. Detecting misconfigurations in network security groups and security lists involves processing the intermediate specification to analyze the configurations of network security groups and security lists, examining the rules, policies, and settings that control access and permissions within the network. The configurations are compared against predefined security standards and best practices, which may include industry guidelines, organizational policies, or regulatory requirements. Deviations from the standards are identified, indicating potential misconfigurations such as incorrect rules, missing policies, or settings that do not align with the intended security posture.

Processing the intermediate specification involves detecting the issue by modeling an authentication process. Detecting issues by modeling an authentication process tests authentication mechanisms for implementation and function to prevent unauthorized access and secure user verification. The parameters of the authentication process are defined based on policy specifications, including user credentials, authentication methods, and access controls. Multiple authentication scenarios are simulated to model user interactions with the authentication mechanisms, which include login attempts, multi-factor authentication, and role-based access. The flow of the authentication process is evaluated to verify that each step is properly executed, checking the validation of credentials, the application of access controls, and the response to authentication attempts. During the evaluation, anomalies or deviations from the expected authentication flow may be identified, which could indicate issues, such as incorrect credential validation, improper access control application, or vulnerabilities in the authentication mechanism.

Processing the intermediate specification involves detecting a least-privilege violation from the intermediate specification. Detecting least-privilege violations from the intermediate specification tests that entities have the minimum access to perform functions, thereby reducing the risk of unauthorized access and potential security breaches. The access permissions defined in the intermediate specification are analyzed, examining the roles, privileges, and access controls assigned to each entity. The analyzed access permissions are compared against least-privilege principles, which specify that entities should have the permissions to perform specific tasks without additional permissions. Instances where entities have excessive permissions that exceed the role based requirements are identified, indicating potential least-privilege violations. The excessive permissions are flagged as least-privilege violations, highlighting areas where access controls are to be tightened to adhere to least-privilege principles. Recommendations for addressing the violations may be generated that specify adjustments to access permissions so that entities have the privileges used for specific tasks without additional privileges.

Processing the intermediate specification involves flagging an information leak as the issue. Flagging an information leak may involve monitoring data flows within the network and between entities, tracking the movement of data to ensure the movement follows the intended paths and access controls specified in the intermediate specification generated from the policy specifications. Data access patterns are analyzed to identify any deviations from expected behavior, examining who accessed the data, when the data was accessed, and how the data was used. Instances of unauthorized access to sensitive data may be detected, which may occur due to misconfigurations, security vulnerabilities, or malicious activities. By correlating data access patterns with security policies and controls specified in the intermediate specification, information leaks, pinpointing where sensitive data has been exposed or accessed without proper authorization, may be identified. Once an information leak is identified, the information leak may be flagged as an issue, highlighting the leak and providing details about the nature and extent of the exposure. Recommendations for mitigating the information leak to secure the exposed data, adjust access controls, and prevent future leaks may be generated.

Processing the intermediate specification involves validating a tag-based information flow. The method for validating tests that data is handled according to predefined tags that specify security levels, access permissions, and other attributes. Tags may be defined from the policy specifications, with tags serving as metadata that specify security levels, access permissions, and other attributes associated with data and entities. The tags may be mapped to the entities and data flows specified within the intermediate specification to check that each entity and data flow is associated with the appropriate tags. The information flow may be simulated within the network or system based on the intermediate specification, tracking how data moves between entities and how tags are applied and enforced. The tag-based data flows may be validated to check that the data flows adhere to the specifications for the tags, to test that data with specific tags is accessed and handled according to the defined security levels and permissions. During validation, violations of the tag-based information flow controls are identified, which may occur when data is accessed or handled in a manner that does not comply with the specifications for the tags. Once identified, the violations are flagged as issues, highlighting areas where tag-based controls may be adjusted for compliance with the policy specifications. Recommendations for addressing the identified issues may be generated to adjust tags, access controls, and data handling procedures to resolve the violations and enhance security.

Block 210 involves displaying the issue. The method for displaying the issue may present the issue to users for review and resolution for management and revision of policy specifications. The issue is identified within the intermediate specification, which may be a misconfiguration, security vulnerability, least-privilege violation, information leak, etc. Detailed information is generated about the identified issue, including the nature, location within the intermediate specification, and relevant context or metadata. An interactive graphical user interface (GUI) may display the issue, which is designed to be user-friendly for easy navigation and interaction. The issue may be highlighted within the graphical user interface using visual cues, such as color coding, icons, lines, boxes, annotations, etc., to draw attention to the issue within the intermediate specification or the policy specifications. Contextual information may be provided to understand the issue, including explanations, potential impacts, and suggestions for resolution. The graphical user interface may process user interaction so that users may view the intermediate specification, view related entities and relations, and access tools for resolving the issue. As the issue is addressed, either automatically or through user interaction, updates to the display may reflect the changes so that the graphical user interface remains current and accurately represents the status of the intermediate specification, the policy specification, resolved issues, etc.

Displaying the issue involves presenting the issue and the intermediate specification in an interactive graphical user interface by adjusting a layout of the interactive graphical user interface to present the issue with the intermediate specification. Presenting the issue and the intermediate specification in an interactive graphical user interface (GUI) may involve adjusting the layout of the graphical user interface to display the issue alongside the intermediate specification as well as one or more of the policy specifications for review to address detected issues. The layout of the graphical user interface may be adjusted to organize the visual elements to show the issue in the context of the definitions for entities, relations, assertions, etc., in the intermediate specification. The issue may be highlighted within the graphical user interface using visual cues, such as color coding, icons, annotations, lines, boxes, etc., to draw attention to the issue. Contextual information about the issue may also be presented, including explanations, potential impacts, and suggestions for resolution. The graphical user interface is responsive to user interaction to navigate the views of the intermediate specification and corresponding policy specifications, to view related entities and relations, and to access tools for resolving the issue. For example, a definition (e.g., for an entity, relation, or assertion) may be highlighted in the intermediate specification as well as the corresponding policy specifications to identify the location of the issue within the policy specifications and a popup may display text that describes the issue detected from analyzing the intermediate specification. The popup may further identify a resolution for the issue, which may be incorporated into policy specifications, and corresponding intermediate specification, upon the selection of an interface element (e.g., when a user presses a button). As issues are addressed, the display may be updated to reflect changes showing the revised policy specifications and regenerating the intermediate specification to represent the current status of the intermediate specification and resolved issues.

The process (200) may further involve generating a policy revision for a policy specification from the set of policy specifications to address the issue. Generating a policy revision for a policy specification to address an identified issue involves updating policy specifications to resolve the issue and maintain compliance with security and operational standards. The issue is identified within the intermediate specification, which could be a misconfiguration, security vulnerability, least-privilege violation, information leak, or other detected problem. The relevant policy specifications are analyzed to identify the context and details of the issue, examining the rules, settings, and controls defined in the policy specifications and locate parts of the policy specifications that cause the issue. Based on the analysis, a policy revision is generated to address the issue, including changes to the policy specifications that resolve the identified problem and enhance security or compliance.

The process (200) may further involve updating the policy specification with the policy revision to resolve the issue. Updating the policy specification with a policy revision to resolve an identified issue involves, after identifying the issue and analyzing the policy specifications, generating a policy revision that addresses the problem, including specific changes to the rules, settings, or controls defined in the policy specifications. The policy revision is validated to ensure the policy revision resolves the issue without introducing new issues, involving testing the revision against the intermediate specification and relevant scenarios. Once validated, the policy revision may be incorporated into the policy specification (automatically or responsive to user interaction), modifying the existing policy specifications to include the changes to resolve the issue. The changes made to the policy specifications may be documented with comments injected into the policy specifications that include details about the issue, the revision, and the rationale behind the changes. The changes made to the policy specification may be communicated with notifications to users, such as administrators, security personnel, and compliance officers, to create awareness of the changes. Implementation of the updated policy specification may be monitored to verify that the changes are applied and effective in resolving the issue, which may involve ongoing evaluation and adjustment.

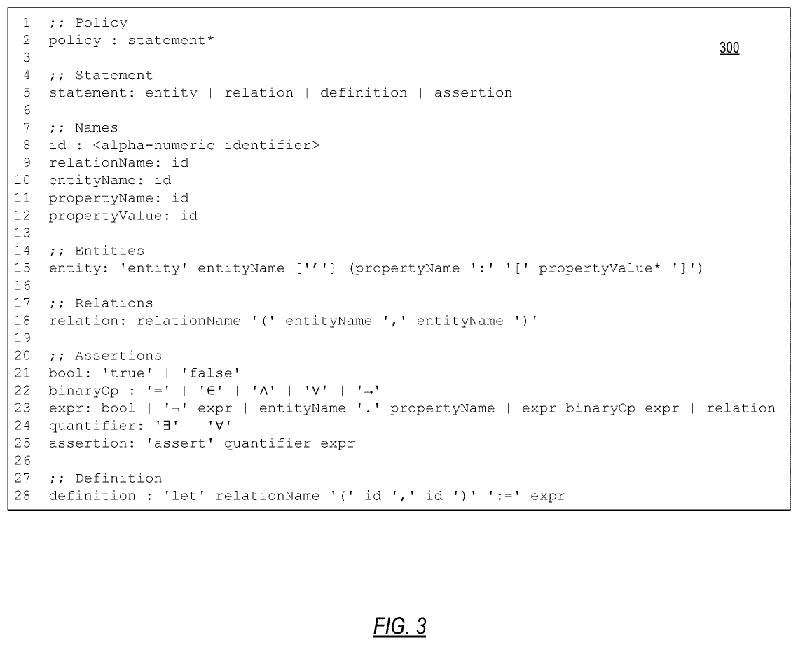

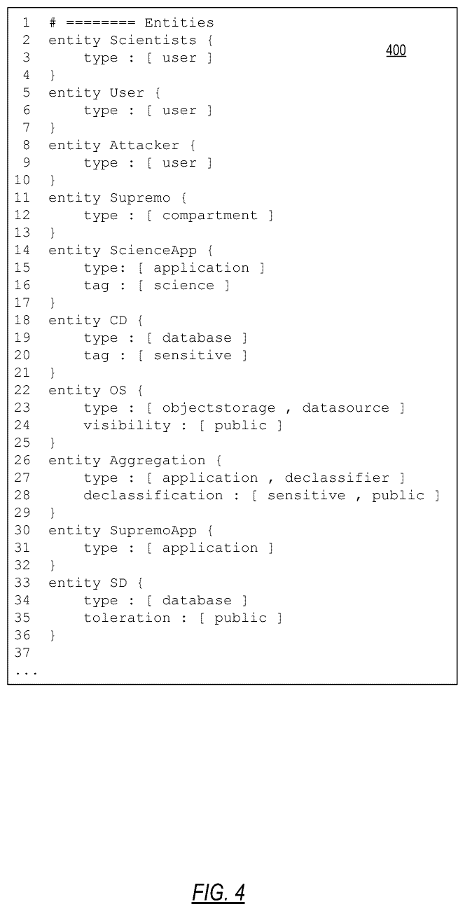

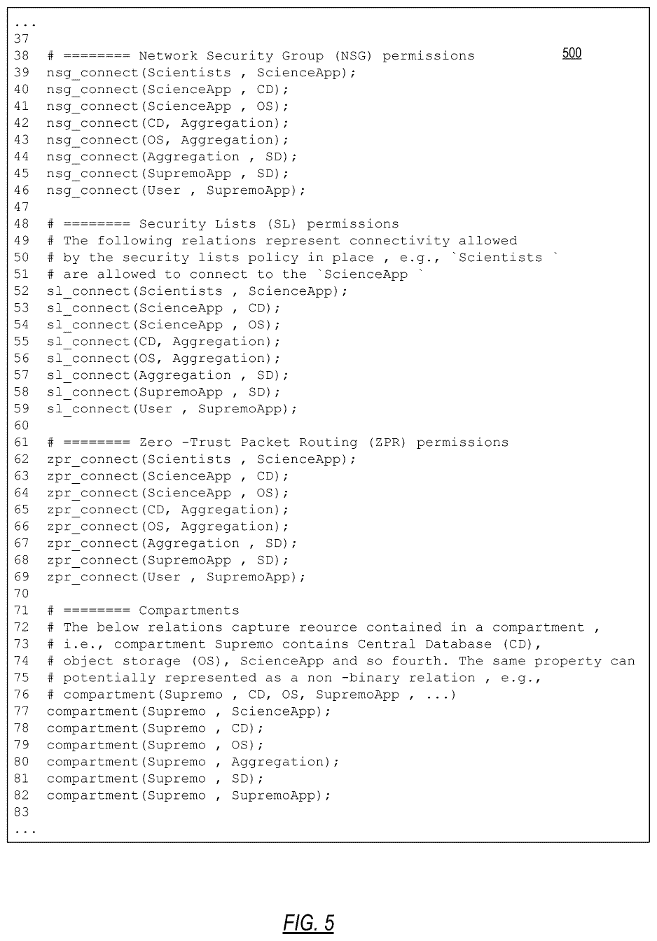

Turning to FIG. 3, the policy intermediate language (300) is one example of a policy intermediate language that specifies the syntax and semantics to use in an intermediate specification for an intermediate representation of a policy specification. The policy intermediate language (300) may be displayed on a graphical user interface of a user device. Line 5 identifies four types of statements that form the definitions in an intermediate specification, including statements for entities, relations, definitions (i.e., local definitions), and assertions. Lines 8 through 12 enumerate the different names used in the definitions. Line 15 identifies the syntax for an entity definition, which includes a name and may include one or more properties that each have a name and a value. Line 18 identifies the syntax for a relation definition, which includes a name and includes the names of entities that have the relation. Lines 21 through 25 specifies the syntax for assertions, which are combinations of binary (i.e., Boolean) expressions. Line 28 identifies the syntax for local definitions that are relations that are combinations of other definitions within an intermediate specification.

Turning to FIG. 4, an intermediate specification includes the section (400) and conforms to the policy intermediate language (300) of FIG. 3. The intermediate specification may be generated from multiple policy specifications. The section (400) may be displayed on a user interface and includes multiple entity definitions. Each of the entity definitions includes properties that have names and values. For example, lines 14 through 17 define an entity named “ScienceApp” that has a property named “type” with the value “application” and has another property named “tag” with the value “science”. The entities defined in lines 2 through 10 define three types of users named “Scientists”, “User”, and “Attacker”. Other types of entities include compartments, applications, object storage, data sources, etc.

Turning to FIG. 5, the section (500) may be after the section (400) of FIG. 4 in an intermediate specification that conforms to the policy intermediate language (300) of FIG. 3. The section (500) may be displayed on a user interface and includes multiple relation definitions. The lines 39 through 46 enumerate several relations named “nsg_connect” between several entities defined in the section (400) of FIG. 4 to represent network security group permissions between the named entities. The lines 52 through 59 enumerate several relations named “sl_connect” between several entities defined in the section (400) of FIG. 4 to represent security list permissions between the named entities. The lines 62 through 69 enumerate several relations named “zpr_connect” between several entities defined in the section (400) of FIG. 4 to represent zero trust packet routing (ZPR) permissions between the named entities. The lines 77 through 82 enumerate several relations named “compartment” between several entities defined in the section (400) of FIG. 4 to identify entities that contain or are compartments of other entities. For example, the entity “Supremo” is a compartment that contains several other entities.

Turning to FIG. 6, the section (600) may be after the section (500) of FIG. 5 in an intermediate specification that conforms to the policy intermediate language (300) of FIG. 3. The section (600) may be displayed on a user interface and includes multiple definitions, including relations, assertions, and local definitions. For example lines 85 through 86 includes two relation definitions, line 87 includes a local definition, and line 88 includes an assertion.

After the intermediate specification is analyzed an issue is identified that relates to the definitions in lines 85 through 88. The assertion at line 88 has that the connect relation to the entity named “CD” (i.e., central database) be by the entity named “ScienceApp” and no other entity. The assertion of line 88 fails due to the relations of lines 85 and 86 in which an entity named “Attacker” has a connect relation to the entity named “CD” in accordance with the local definition from line 87.

Responsive to identifying the issue the boxes (612) and (622) may be displayed on the section (600) to identify the location of the issues within the intermediate specification. A user may interact with the boxes (612) and (622), e.g., by hovering a cursor over the boxes (612) and (622) to trigger display of the interface element (628).

The interface element (628) is a popup window that provides an explanation for the issue and a potential resolution to the issue. When the user clicks on the interface element (628) the system may operate to update the policy specifications related to the lines 85 and 86 to remove the connect relation that the entity named “Attacker” has with the entity named “CD”. The update to the policy specifications may operate to remove the connection between the entity named “Attacker” and the entity named “CD”. After performing the update, the intermediate specification may be regenerated and the display of the section (600) may be updated to show the changes in the intermediate specification based on the changes to the policy specifications to resolve the issue.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 7A, the computing system (700) may include one or more computer processor(s) (702), non-persistent storage device(s) (704), persistent storage device(s) (706), a communication interface (708) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) (702) may be one or more cores, or micro-cores, of a processor. The computer processor(s) (702) includes one or more processors. The computer processor(s) (702) may include a central processing unit (CPU), a graphics processing unit (GPU), a tensor processing unit (TPU), combinations thereof, etc.

The input device(s) (710) may include a touchscreen, keyboard, mouse, microphone, touchpad, electronic pen, or any other type of input device. The input device(s) (710) may receive inputs from a user that are responsive to data and messages presented by the output device(s) (712). The inputs may include text input, audio input, video input, etc., which may be processed and transmitted by the computing system (700) in accordance with one or more embodiments. The communication interface (708) may include an integrated circuit for connecting the computing system (700) to a network (not shown) (e.g., a local area network (LAN), a wide area network (WAN), such as the Internet, mobile network, or any other type of network) or to another device, such as another computing device, and combinations thereof.

Further, the output device(s) (712) may include a display device, a printer, external storage, or any other output device. One or more of the output device(s) (712) may be the same or different from the input device(s) (710). The input device(s) (710) and output device(s) (712) may be locally or remotely connected to the computer processor(s) (702). Many different types of computing systems exist, and the aforementioned input device(s) (710) and output device(s) (712) may take other forms. The output device(s) (712) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (702), is configured to perform one or more embodiments, which may include transmitting, receiving, presenting, and displaying data and messages described in the other figures of the disclosure.

The computing system (700) in FIG. 7A may be connected to, or be a part of, a network. For example, as shown in FIG. 7B, the network (720) may include multiple nodes (e.g., node X (722) and node Y (724), as well as extant intervening nodes between node X (722) and node Y (724)). Each node may correspond to a computing system, such as the computing system shown in FIG. 7A, or a group of nodes combined may correspond to the computing system shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722) and node Y (724)) in the network (720) may be configured to provide services for a client device (726). The services may include receiving requests and transmitting responses to the client device (726). For example, the nodes may be part of a cloud computing system. The client device (726) may be a computing system, such as the computing system shown in FIG. 7A. Further, the client device (726) may include or perform all or a portion of one or more embodiments.

The computing system of FIG. 7A may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a set of policy specifications conforming to a set of policy languages;
translating the set of policy specifications to an intermediate specification conforming to a policy intermediate language, wherein the intermediate specification comprises:
a set of entity definitions defining a set of entities identified by the set of policy specifications,
a set of relation definitions defining a set of relations between the set of entities, and
a set of assertion definitions defining logical properties using one or more of the set of entity definitions and the set of relation definitions;
processing the intermediate specification to detect an issue in the intermediate specification from the set of policy specifications; and
displaying the issue.

2. The method of claim 1, wherein the intermediate specification comprises a set of local definitions defining a set of compound relations using the set of relation definitions.

3. The method of claim 1, wherein processing the intermediate specification further comprises:
determining reachability between the set of entities by processing the set of entity definitions using transitive closure definitions to identify indirect connections between the set of entities.

4. The method of claim 1, wherein processing the intermediate specification further comprises:
detecting a misconfiguration in one or more of a network security group and a security list.

5. The method of claim 1, wherein processing the intermediate specification further comprises:
detecting the issue by modeling an authentication process.

6. The method of claim 1, wherein processing the intermediate specification further comprises:
detecting a least-privilege violation from the intermediate specification.

7. The method of claim 1, wherein processing the intermediate specification further comprises:
flagging an information leak as the issue.

8. The method of claim 1, wherein processing the intermediate specification further comprises:
validating a tag-based information flow.

9. The method of claim 1, wherein displaying the issue further comprises:
presenting the issue and the intermediate specification in an interactive graphical user interface by adjusting a layout of the interactive graphical user interface to present the issue with the intermediate specification.

10. The method of claim 1, further comprising:
generating a policy revision for a policy specification from the set of policy specifications to address the issue; and
updating the policy specification with the policy revision to resolve the issue.

11. A system comprising:
at least one computer processor; and
an application that, when executing on the at least one computer processor, performs operations comprising:
receiving a set of policy specifications conforming to a set of policy languages,
translating the set of policy specifications to an intermediate specification conforming to a policy intermediate language, wherein the intermediate specification comprises:
a set of entity definitions defining a set of entities identified by the set of policy specifications,
a set of relation definitions defining a set of relations between the set of entities, and
a set of assertion definitions defining logical properties using one or more of the set of entity definitions and the set of relation definitions,
processing the intermediate specification to detect an issue in the intermediate specification from the set of policy specifications, and
displaying the issue.

12. The system of claim 11, wherein the intermediate specification comprises a set of local definitions defining a set of compound relations using the set of relation definitions.

13. The system of claim 11, wherein processing the intermediate specification further comprises:
determining reachability between the set of entities by processing the set of entity definitions using transitive closure definitions to identify indirect connections between the set of entities.

14. The system of claim 11, wherein processing the intermediate specification further comprises:
detecting a misconfiguration in one or more of a network security group and a security list.

15. The system of claim 11, wherein processing the intermediate specification further comprises:
detecting the issue by modeling an authentication process.

16. The system of claim 11, wherein processing the intermediate specification further comprises:
detecting a least-privilege violation from the intermediate specification.

17. The system of claim 11, wherein processing the intermediate specification further comprises:
flagging an information leak as the issue.

18. The system of claim 11, wherein processing the intermediate specification further comprises:
validating a tag-based information flow.

19. The system of claim 11, wherein displaying the issue further comprises:
presenting the issue and the intermediate specification in an interactive graphical user interface by adjusting a layout of the interactive graphical user interface to present the issue with the intermediate specification.

20. A non-transitory computer readable medium comprising instructions executable by at least one computer processor to perform:
receiving a set of policy specifications conforming to a set of policy languages;
translating the set of policy specifications to an intermediate specification conforming to a policy intermediate language, wherein the intermediate specification comprises:
a set of entity definitions defining a set of entities identified by the set of policy specifications,
a set of relation definitions defining a set of relations between the set of entities, and
a set of assertion definitions defining logical properties using one or more of the set of entity definitions and the set of relation definitions;
processing the intermediate specification to detect an issue in the intermediate specification from the set of policy specifications; and
displaying the issue.
